(19) United States
(12) Patent Application Publication
(10) Pub. No.: US 2026/0112159 A1
(43) Pub. Date: Apr. 23, 2026

(54) METHOD AND APPARATUS FOR ESTIMATED UNIT DECOMPOSITION MODELING ASSOCIATED WITH EXPECTED LOADING SHAPE

(71) Applicants: Hyundai Motor Company, Seoul (KR); Kia Corporation, Seoul (KR)

(72) Inventors: Jongho SHIN, Hwaseong-Si (KR); Sunkyung CHOI, Hwaseong-Si (KR)

(21) Appl. No.: 19/361,519

(22) Filed: Oct. 17, 2025

(30) Foreign Application Priority Data
Oct. 18, 2024 (KR) 10-2024-0143187
Sep. 19, 2025 (KR) 10-2025-0135444

(51) Int. Cl. G06V 20/20; G06T 19/00; G06V 10/762; G06V 20/52; G06V 20/64

(52) U.S. Cl. CPC G06V 20/20; G06T 19/006; G06V 10/762; G06V 20/52; G06T 2210/12; G06V 20/647

(57) ABSTRACT

A method and an apparatus for providing work instructions in air cargo logistics are provided. The method may include: recognizing, via a camera of the apparatus, a parcel and obtaining information on the parcel; generating, based on the obtained information, an estimated unit decomposition model of the parcel; identifying, based on environmental information and user information of the apparatus, a loading worksite for the parcel; determining, based on the estimated unit decomposition model, an expected loading shape of a unit load device (ULD); and outputting, via an augmented reality (AR) device, the expected loading shape.

### CROSS-REFERENCE TO RELATED APPLICATION

This application claims priority to and the benefit of Korean Patent Application No. 10-2024-0143187, filed with the Korean Intellectual Property Office on Oct. 18, 2024, and Korean Patent Application No. 10-2025-0135444, filed with the Korean Intellectual Property Office on Sep. 19, 2025, the entire contents of which are incorporated herein by reference.

### TECHNICAL FIELD

The present disclosure relates to a method and an apparatus for air cargo logistics.

### BACKGROUND

In the field of transporting air cargo, the process of loading cargo into a unit load device (ULD) may depend on the experience and intuition of workers. However, since cargo received in units of pallets or separation numbers does not readily provide accurate dimensions and shapes of individual parcels, it may be difficult to determine (e.g., calculate) in advance an expected loading rate during the actual loading process. In addition, because it is difficult for workers to accurately determine the loading position and shape, there is a problem in that loading efficiency is reduced and duplicative work frequently occurs. Furthermore, confusion may occur in the loading process since it is not possible to determine whether the cargo has a regular pattern or an irregular pattern, or whether cargo exists in blind spots during the work.

### SUMMARY

An object to be solved is to provide a method and an apparatus for providing work instructions in air cargo logistics, which enable intuitive confirmation of a loading shape and an expected loading rate when loading cargo into a Unit Load Device (ULD) in the air cargo field, thereby improving work efficiency.

According to one or more example embodiments of the present disclosure, a method performed by an apparatus may include: recognizing, via a camera of the apparatus, a parcel and obtaining information on the parcel; generating, based on the obtained information, an estimated unit decomposition model of the parcel; identifying, based on environmental information and user information of the apparatus, a loading worksite for the parcel; determining, based on the estimated unit decomposition model, an expected loading shape of a unit load device (ULD); and outputting, via an augmented reality (AR) device, the expected loading shape.

Recognizing the parcel and obtaining the information on the parcel may include: utilizing an Air Waybill (AWB) as a unique identifier of the parcel at a reservation stage; determining a quantity of pieces (PCS) units of the parcel as a key value; and quantifying separation number information by using a post-warehousing inspection and a volume measurement system (VMS).

Generating the estimated unit decomposition model of the parcel may include: generating modeling data based on the separation number information measured by the VMS; and mapping the modeling data with an auxiliary database to construct a digital shape of the parcel.

Generating the estimated unit decomposition model of the parcel may further include: obtaining an exterior surface of the modeling data and assigning an identifier to each of the PCS units of the parcel; and estimating, based on the exterior surface and the identifier, dimensions of the PCS units.

Generating the estimated unit decomposition model of the parcel may further include: distinguishing boundary surfaces of the modeling data based on positional differences in the boundary surfaces; and adjusting the decomposition model of the PCS units by inferring deficient or excessive components using correlations between boxes.

Generating the estimated unit decomposition model of the parcel may include: estimating individual boxes as a cluster of cargo of uniform size based on dimensions of the individual boxes analyzed in a decomposition process of the parcel exhibiting a same pattern within a predetermined margin of error.

The method may further include: based on the individual boxes being estimated as the cluster of cargo of uniform size, decomposing the parcel based on a combination of the dimensions and a number of PCS units; and switching to a non-uniform cargo cluster pattern analysis based on conditions of uniform cargo cluster not being satisfied.

Generating the estimated unit decomposition model of the parcel may further include: assigning dimensions to each individual cargo identifier based on the non-uniform cargo cluster pattern analysis confirming that all photographed cargo are in a box shape.

The method may further include: estimating cargo, in blind spots, that is not recognized during the non-uniform cargo cluster pattern analysis and applying the estimated cargo in the estimated unit decomposition model of the PCS units.

The method may further include: generating a signal to change a location of the camera to capture a plurality of side surface images of the ULD; while the location of the camera is changing, obtaining the plurality of side surface images of the ULD to construct a three-dimensional model of the ULD; and based on recognizing the ULD with the camera, displaying an outline of the ULD as a boundary area and outputting, via the AR device, expected loaded cargo as a translucent object.

According to one or more example embodiments of the present disclosure, an apparatus may include: a processor; and a memory storing at least one instruction that is configured, when executed by the processor, to cause the apparatus to: recognize, via a camera associated with the apparatus, a parcel and obtain information on the parcel; generate, based on the obtained information, an estimated unit decomposition model of the parcel; identify, based on environmental information and user information of the apparatus, a loading worksite for the parcel; determine, based on the estimated unit decomposition model, an expected loading shape of a unit load device (ULD); and output, via an augmented reality (AR) device, the expected loading shape.

The at least one instruction may be configured, when executed by the processor, to cause the apparatus to recognize the parcel and obtain the information on the parcel by: utilizing an Air Waybill (AWB) as a unique identifier of the parcel at a reservation stage; determining a quantity of pieces (PCS) units of the parcel as a key value; and quantifying separation number information by using a post-warehousing inspection and a volume measurement system (VMS).

The at least one instruction may be configured, when executed by the processor, to cause the apparatus to generate the estimated unit decomposition model of the parcel by: generating modeling data based on the separation number information measured by the VMS; and mapping the modeling data with an auxiliary database to construct a digital shape of the parcel.

The at least one instruction may be configured, when executed by the processor, to cause the apparatus to generate the estimated unit decomposition model of the parcel further by: obtaining an exterior surface of the modeling data and assigning an identifier to each of the PCS units of the parcel; and estimating, based on the exterior surface and the identifier, dimensions of the PCS units.

The at least one instruction may be configured, when executed by the processor, to cause the apparatus to generate the estimated unit decomposition model of the parcel further by: distinguishing boundary surfaces of the modeling data based on positional differences in the boundary surfaces; and adjusting the decomposition model of the PCS units by inferring deficient or excessive components using correlations between boxes.

The at least one instruction may be configured, when executed by the processor, to cause the apparatus to generate the estimated unit decomposition model of the parcel by: estimating individual boxes as a cluster of cargo of uniform size based on dimensions of the individual boxes analyzed in a decomposition process of the parcel exhibiting a same pattern within a predetermined margin of error.

The at least one instruction may be configured, when executed by the processor, to further cause the apparatus to: based on the individual boxes being estimated as the cluster of cargo of uniform size, decomposing the parcel based on a combination of the dimensions and a number of PCS units; and switching to a non-uniform cargo cluster pattern analysis based on conditions of uniform cargo cluster not being satisfied.

The at least one instruction may be configured, when executed by the processor, to further cause the apparatus to generate the estimated unit decomposition model of the parcel further by: assigning dimensions to each individual cargo identifier based on the non-uniform cargo cluster pattern analysis confirming that all photographed cargo are in a box shape.

The at least one instruction may be configured, when executed by the processor, to further cause the apparatus to: estimate cargo, in blind spots, that is not recognized during the non-uniform cargo cluster pattern analysis and applying the estimated cargo in the decomposition model of the PCS units.

According to one or more example embodiments of the present disclosure, one or more non-transitory computer-readable media may store instructions that, when executed by a computing device, cause the computing device to: recognize, via a camera associated with the computing device, a parcel and obtain information on the parcel; generate, based on the obtained information, an estimated unit decomposition model of the parcel; identify, based on environmental information and user information of the computing device, a loading worksite for the parcel; determine, based on the estimated unit decomposition model, an expected loading shape of a unit load device (ULD); and output, via an augmented reality (AR) device, the expected loading shape.

### BRIEF DESCRIPTION OF THE DRAWINGS

FIG. 1 is a diagram showing an example apparatus for providing work instructions in air cargo logistics.

FIG. 2 is a flow diagram of an example method for providing work instructions in air cargo logistics.

FIGS. 3, 4, and 5 are diagrams showing implementation examples of an apparatus and a method for providing work instructions in air cargo logistics.

FIG. 6 is a diagram of an example computing device.

### DETAILED DESCRIPTION

Hereinafter, one or more example embodiments of the present disclosure will be described in detail with reference to the accompanying drawings so that those skilled in the art to which the present disclosure pertains can easily implement the present disclosure. However, the present disclosure may be implemented in various different forms and is not limited to the example embodiment(s) described herein. In the drawings, in order to clearly illustrate the present disclosure, parts irrelevant to the description have been omitted, and like reference numerals are assigned to like parts throughout the specification.

Unless otherwise defined, the terms used herein, including technical or scientific terms, may have meanings generally understood by those skilled in the art to which the present disclosure belongs.

In the entire specification and claims, when a part is referred to as “comprising” a component, this means that, unless specifically stated otherwise, the part does not exclude other components but may further include other components. Terms including ordinals such as first, second, and the like may be used to describe various components, but the components are not limited by the terms. The terms are only used to distinguish one component from another component.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The terms “ . . . unit” and “ . . . module” described in the specification may refer to a unit capable of processing at least one function or operation described in the specification, and may be implemented in hardware or circuitry, software, or a combination of hardware or circuitry and software. In addition, at least some configurations or functions of the method and apparatus for providing work instructions in air cargo logistics according to the example embodiment(s) described below may be implemented as a program or software, and the program or software may be stored in a computer-readable recording medium or storage medium. The term “unit” and/or “module” as used herein may refer to software, or hardware component such as Field-Programmable Gate Array (FPGA), Application Specific Integrated Circuit (ASIC), etc. However, “unit” and/or “module” is not limited to hardware and software. The “unit“ and/or “module” may be configured to be stored in an addressable storage medium, or may be configured to execute one or more processors. The “unit” and/or “module” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

A mobility apparatus (also referred to as a mobility device) may be any apparatus, device, or vehicle capable of movement. A mobility apparatus may be capable of movement by means of self-propulsion using, for example, one or more motors or engines. A mobility apparatus may be capable of traversing over and/or across different terrains and spaces, such as land, underground, air, space, sea, and/or underwater. Land or underground mobility apparatuses may be provided, for example, in the form of vehicles (e.g., automobiles, cars, trucks, buses, motorcycles, mopeds, bicycles, mobility scooters, etc.) or robots. Air or space mobility apparatuses may be provided, for example, in the form of air mobility apparatuses, such as fixed-wing or rotary-wing aircraft, advanced air mobility (AAM) devices, unmanned aerial vehicles, drones, rockets, or vehicles mounted on satellites. Marine or underwater mobility devices may include, for example, ships, boats, jet skis, hovercraft, submarines, etc. A mobility apparatus may move across multiple terrains or spaces. A mobility apparatus may provide air cargo logistics.

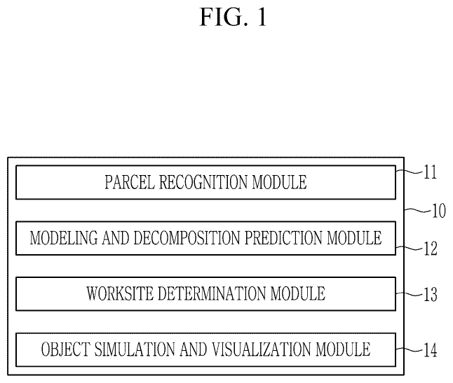

FIG. 1 is a diagram showing an example apparatus for providing work instructions in air cargo logistics.

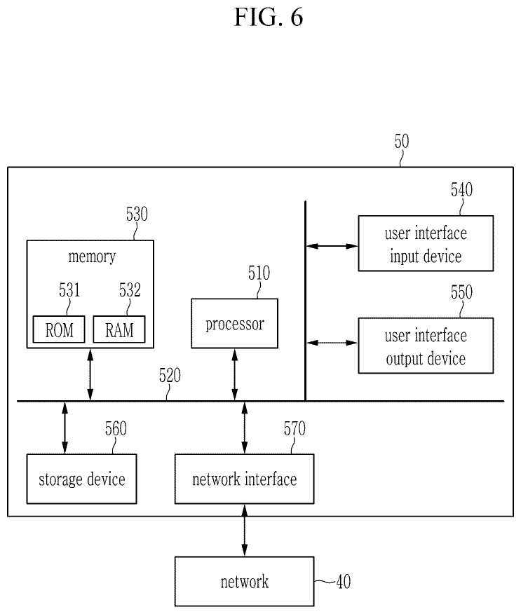

Referring to FIG. 1, an apparatus 10 for providing work instructions in air cargo logistics may be implemented as a computing device including a processor and a memory. For example, the apparatus 10 for providing work instructions in air cargo logistics may be implemented as the computing device 50 as described later in connection with FIG. 6. In this case, the processor may correspond to the processor 510 of the computing device 50, and the memory may correspond to the memory 520 of the computing device 50. Alternatively, the apparatus 10 for providing work instructions in air cargo logistics may include one or more non-transitory computer-readable media including instructions and one or more processors configured to perform operations by executing the instructions. Here, the operations may include the configurations, functions, and steps described in the present specification regarding the method and apparatus for providing work instructions in air cargo logistics. In the present specification, the term “module” is used to logically distinguish these operations performed by the method and apparatus for providing work instructions in air cargo logistics.

The apparatus 10 for providing work instructions in air cargo logistics may include a parcel recognition module 11, a modeling and decomposition prediction module 12, a worksite determination module 13, and an object simulation and visualization module 14.

The parcel recognition module 11 may recognize a parcel through a camera of the terminal device and extract information on the parcel. Here, the terminal device may correspond to the apparatus 10 for providing work instructions in air cargo logistics. The terminal device may be, for example, a computer, a wearable computing device, a smart phone, a tablet computing device, an augmented reality (AR) device, a virtual reality (VR) device, a smart glass, smart goggles, a head-up display (HUD), a robot, an unmanned aerial vehicle, etc. The camera may be an imaging device that can be used to acquire an image of the parcel.

The parcel may refer to an individual cargo unit loaded into a Unit Load Device (ULD) or a pallet during air transportation. The parcel may be distinguished by an Air Waybill (AWB), may be warehoused as grouped under a separation number, and within the separation number may be further subdivided into a plurality of individual parcel units, i.e., Pieces (PCS) units or cargo units. That is, the parcel may correspond to an individual unit cargo, in contrast to pallet-level cargo as a higher unit, and may have inconsistent size and shape, and may have various forms of regular (for example, box-shaped) or irregular shapes.

The information on the parcel may include identification information such as an Air Waybill number or a separation number for identifying the parcel, physical specification information such as width, length, height, volume, or weight of the parcel, and appearance information such as an outer shape, surface pattern, or material characteristics of the parcel. In addition, detailed unit information such as the number of PCS included in the parcel and IDs assigned to each PCS unit may also be included in the information on the parcel.

The parcel recognition module 11 may include utilizing an AWB as a unique identifier (ID) of the parcel at a reservation stage, managing a quantity of PCS units as a key value, and quantifying separation number information by using a post-warehousing inspection and a Volume Measurement System (VMS).

The modeling and decomposition prediction module 12 may generate or predict a unit decomposition model (also referred to as a unit composition model) of the parcel based on the information extracted by the parcel recognition module 11. Here, the unit decomposition model may refer to a digital model including dimensions, shapes, positions, and volumes of each PCS unit obtained by decomposing the parcel into PCS units. The unit decomposition model may correspond to a result of converting an overall volume of the parcel into decomposable units based on identification information such as an AWB, a separation number, and PCS information. In addition, the unit decomposition model of the parcel may be a digital simulation result that predictively represents shapes and arrangement states of individual PCS units constituting the actual parcel, and may be used as input data of a loading algorithm to calculate a ULD loading shape and an expected loading rate.

The modeling and decomposition prediction module 12 may generate modeling data based on separation number information measured by the VMS, and may construct a digital shape of the parcel (e.g., a digital representation of a contour of the parcel) by mapping the modeling data with an auxiliary database. Here, the modeling data may be three-dimensional shape data generated based on dimensions, volume, and appearance shape information of separation number units acquired from the VMS. The modeling data may represent outlines or boundary surfaces of the parcel as polygons, or may be simplified and represented as rectangular parallelepiped data in the form of boxes, and in some cases may further include pattern information extracted through image analysis. In addition, the modeling data may be assigned expected dimensions and IDs of each PCS unit, and may represent an entire structure of the parcel as subdivided units. Meanwhile, the auxiliary database may include reference information necessary to adjust (e.g., correct) or interpret the modeling data. For example, the auxiliary database may store reservation and warehousing history of the parcel, AWB numbers, quantities of PCS, logistics terminal environmental information, and past measurement data.

By mapping the modeling data with the auxiliary database, an overall digital shape of the parcel that is difficult to secure only with measured dimension values may be constructed, and the constructed digital shape may subsequently improve prediction accuracy of the unit decomposition model and may be used as input data of a ULD loading algorithm.

The modeling and decomposition prediction module 12 may extract exterior surfaces of the modeling data, assign IDs to each PCS unit, and predict dimensions of the PCS units. Here, extracting the exterior surfaces may mean analyzing boundary lines of three-dimensional modeling data measured by the VMS to identify surfaces forming an outer shape of the parcel. The exterior surfaces may be defined such that boundaries between adjacent surfaces are separated by using edge detection algorithms or image analysis techniques, and thereby PCS units may be distinguished within an overall parcel modeling. Once each PCS unit is distinguished, a unique ID may be assigned to the distinguished PCS unit.

Meanwhile, dimensions of each PCS unit may be calculated based on boundary lengths and heights of the exterior surfaces. As width, length, and height dimensions are predicted, volumes and shapes of the PCS units may be defined, and these may be used as input data of the ULD loading algorithm and for calculating loading rates.

The modeling and decomposition prediction module 12 may analyze and divide (e.g., distinguish, classify, category, etc.) boundary surfaces of the modeling data by step differences, and may adjust (e.g., correct) a decomposition model of PCS units by inferring deficient or excessive components using correlations between boxes. Here, analyzing the boundary surfaces by step differences (e.g., positional differences) may mean detecting height differences, depth differences, or geometric discontinuities of adjacent surfaces in three-dimensional modeling data measured by the VMS, and distinguishing (e.g., classifying, categorizing, etc.) individual blocks constituting the parcel. Through such analysis, tentative boundaries of the PCS units may be established.

At this time, correlations between boxes may be derived by utilizing dimensions, patterns, and arrangement rules of other PCS units included in the same separation number. For example, in the case of repetitive regular cargo having the same dimensions, even if dimensions are incompletely extracted on some surfaces, missing portions may be inferred based on correlations with other boxes, while excessively extracted components may be adjusted (e.g., corrected) based on an average value or regularity within the cluster. Accordingly, a unit decomposition model more similar to an actual state may be constructed.

The modeling and decomposition prediction module 12 may estimate individual boxes as a cluster of regular cargo (e.g., cargo of uniform size) when World Dimensions (WLDs) of the individual boxes analyzed in a decomposition process of the parcel exhibit the same pattern within a margin of range (e.g., predetermined margin of error). Here, the WLDs exhibiting the same pattern within a margin of range may mean that width, length, and height values of each box match within a predetermined tolerance range. For example, when a plurality of boxes are determined to all have the same standard rectangular parallelepiped form, these boxes may be regarded as regular cargo. In such a case where the boxes are estimated as a cluster of regular cargo, the modeling and decomposition prediction module 12 may simplify the unit decomposition model by repeatedly arranging a plurality of boxes having the same dimensions. By processing in this manner, a decomposition speed of cargo having repetitive patterns may be improved and computing resources may be saved.

If parcels are estimated as a cluster of regular cargo, the modeling and decomposition prediction module 12 may decompose the entire parcel based on a combination of WLDs and a number of PCS units, and may switch to an irregular (e.g., non-uniform) cargo cluster pattern analysis when conditions of the regular cargo cluster are not satisfied. Accordingly, when the parcel has a regular pattern, efficiency may be improved, and when the parcel has an irregular pattern, accuracy may be ensured, thereby providing a stable unit decomposition model for various types of cargo.

The modeling and decomposition prediction module 12 may, when it is confirmed in an irregular cargo cluster pattern analysis that all photographed cargo are in a box shape, assign dimensions to each individual ID cargo, and may estimate cargo in blind spots that are not directly recognized in the irregular cargo cluster pattern analysis and reflect (e.g., apply) the estimated cargo in a decomposition model of the PCS units.

Here, confirmation of whether the cargo are in a box shape may be performed by applying an outline detection or surface recognition algorithm to a photographed image, and when each cargo satisfies basic geometric characteristics of a rectangular parallelepiped, it may be determined to be in a box shape. At this time, each cargo may be matched with an ID assigned by the parcel recognition module 11, and width, length, and height dimensions may be recorded in the corresponding ID. Such dimension values may be adjusted (e.g., corrected) in combination with VMS measurement data.

Meanwhile, estimation of cargo in blind spots may be performed to compensate for limitations of camera shooting angles, occurrence of shadows, or areas obscured by other cargo, and estimation may be made by utilizing dimension and positional relationships of adjacent boxes and repetitive pattern information within the same cluster. The estimated blind spot cargo may be inserted as a new PCS unit into the model, or may be added to a missing area in an existing decomposition model.

The worksite determination module 13 may determine a loading worksite by recognizing environmental information and user information of the terminal device. Here, the environmental information may be information collected through a camera, a location sensor, or a wireless communication module of the terminal device, and may include coordinates of a specific area in a logistics terminal where the terminal device is located, image patterns of surrounding structures, or wireless network signal strengths. The environmental information may be compared and matched with reference data registered in advance in the logistics terminal, and may be used to identify in which area the terminal device is located. The user information may include an ID of a worker logged into the terminal device, shift information, or a work schedule assigned from a logistics management server. That is, the worksite determination module 13 may automatically designate a loading worksite by comprehensively considering the environmental information and the user information, matching a terminal environment where the terminal device is currently located with a work area assigned to the worker. As the worksite is determined, visualization of the unit decomposition model of the parcel and output of the ULD loading shape may be implemented to correspond to an actual area assigned to the worker.

The object simulation and visualization module 14 may apply the unit decomposition model and a loading algorithm to calculate an expected loading shape of the ULD and may output the expected loading shape through an augmented reality (AR) device. When recognizing the ULD with a camera, the object simulation and visualization module 14 may display an outer shape (e.g., outline, silhouette, etc.) of the ULD as a boundary area and may output expected loaded cargo as translucent objects through an AR device. The AR device may be, for example, a wearable computing device, a smart glass, a heads-up display, smart goggles, a virtual reality (VR) device, a two-dimensional (2D) display device, a three-dimensional (3D) display device, etc. For example, an apparatus (e.g., a robot) may generate a signal to change a location of the camera to capture a plurality of side surface images of the ULD, and, while the location of the camera is changing, obtain the plurality of side surface images of the ULD to construct a three-dimensional model of the ULD.

Here, the expected loading shape may be a result derived by applying dimensions, volumes, and arrangement directions of individual PCS units included in the unit decomposition model to a loading algorithm, and an occupancy rate of the entire ULD and an expected loading rate may be calculated together. The calculated expected loading shape may be displayed as AR objects superimposed on an image from the camera of the terminal device. For example, parcels not yet loaded may be output overlapped inside the ULD in a translucent box form, and remaining loading space may be visually displayed in comparison with parcels already loaded. A worker may intuitively check an expected loading rate, loading direction, and remaining space through a screen of the terminal device, and may thereby perform efficient loading work without relying on experience.

When loading parcels into a ULD in the air cargo field, dimensions and shapes of the individual parcel units can be predicted and an accurate loading rate can be calculated. In addition, by distinguishing between regular cargo and irregular cargo and estimating cargo in blind spots, a unit decomposition model similar to an actual state can be provided. Furthermore, based on environmental information and user information, a loading worksite can be automatically designated, and by visualizing an expected loading shape and a loading rate through AR (e.g., an AR device), work instructions can be provided in a highly immersive manner while reducing confusion of workers.

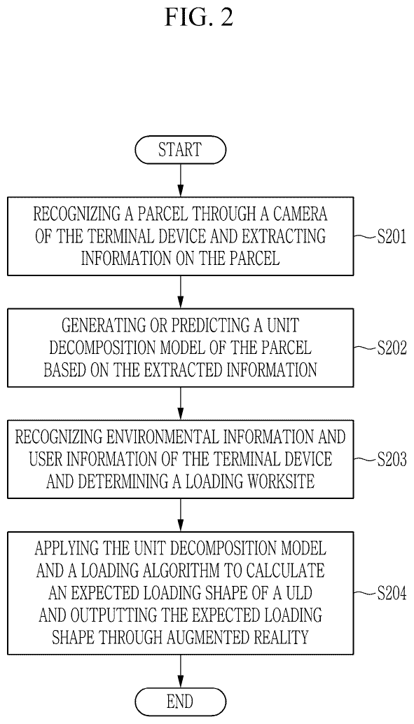

FIG. 2 is a flow diagram of an example method for providing work instructions in air cargo logistics.

Referring to FIG. 2, a method for providing work instructions in air cargo logistics may include: recognizing a parcel through a camera of the terminal device and extracting information on the parcel (S201); generating or predicting a unit decomposition model of the parcel based on the extracted information (S202); recognizing environmental information and user information of the terminal device and determining a loading worksite (S203); and applying the unit decomposition model and a loading algorithm to calculate an expected loading shape of a Unit Load Device (ULD) and outputting the expected loading shape through augmented reality (S204).

More detailed descriptions of the method may be found in the descriptions herein, and thus overlapping descriptions will be omitted.

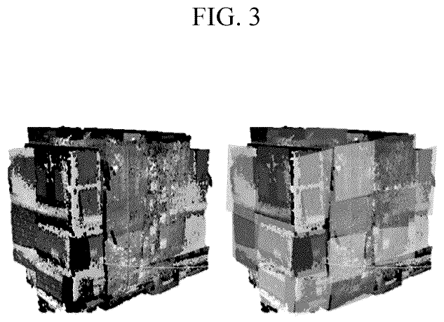

FIGS. 3, 4, and 5 are diagrams showing implementation examples of an apparatus and a method for providing work instructions in air cargo logistics.

Referring to FIG. 3, the left side shows a result of shaping modeling data based on information measured through the VMS and mapping the modeling data with an auxiliary database, and the right side shows a result of extracting exterior surfaces from the modeling data, assigning PCS IDs to cargo, and predicting dimensions.

As can be seen on the left, in an initial stage, parcels are measured as they are stacked, and therefore, an overall shape of the cargo is complex and boundaries are not clearly distinguished. Accordingly, measurement data obtained from the VMS may be mapped with an auxiliary database so as to be linked with reservation information, AWBs, PCS quantities, and the like of each parcel, and may be used as reference data for possible decomposition in subsequent stages.

On the right, as exterior surfaces are extracted, boundaries of individual box units are derived, and unique IDs are assigned to and visually displayed on each PCS. In addition, as boundaries of the box units are represented by different colors, it can be intuitively understood that cargo appearing to be a single aggregate is actually composed of multiple PCS units. Such PCS unit models, for which dimensions are predicted, may be input into a loading algorithm and used as base data to calculate an optimal loading shape and an expected loading rate in the ULD.

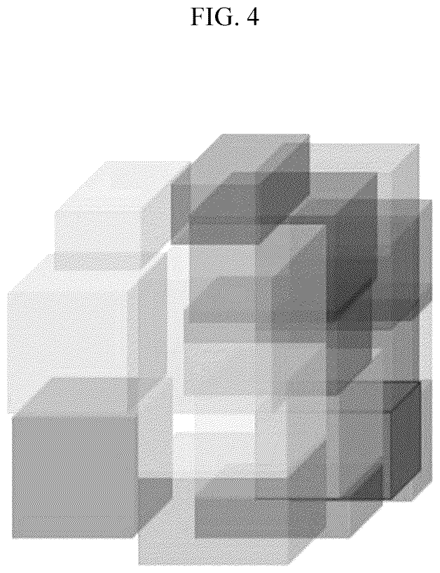

Referring to FIG. 4, a result of extracting modeling data reconstructed into PCS sub-boxes is shown.

Here, each sub-box represents an individual PCS unit constituting the parcel, and is distinguished and displayed in different colors. Through this, it can be intuitively confirmed how a plurality of PCS units are arranged within an overall cargo structure, and each PCS unit may be defined to have a unique ID and dimensions. The reconstructed modeling data is derived based on mapping results of VMS measurement information and the auxiliary database, followed by extraction of exterior surfaces and boundary analysis and adjustment (e.g., correction) processes. Accordingly, the result shown in FIG. 4 visually demonstrates a state in which cargo in an original aggregate form is subdivided into PCS units and converted into a digital model.

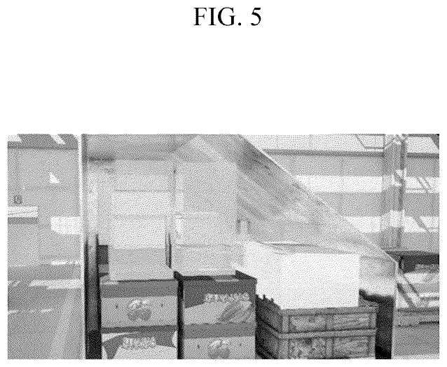

Referring to FIG. 5, an example of a screen of a terminal device viewed by a worker is shown, in which expected cargo upon photographing the ULD may be represented as translucent objects and an expected loading rate may also be displayed.

Here, the camera of the terminal device recognizes actually loaded cargo, and the object simulation and visualization module 14 may output an expected loading shape, calculated by applying the unit decomposition model and a loading algorithm, superimposed on the screen in the form of translucent boxes. Through this, the worker may intuitively check positions and orientations in which cargo not yet loaded will be placed inside the ULD. In addition, an expected loading rate considering a currently loaded amount and a remaining space may be displayed numerically on the screen. As the actual environment image and AR objects are displayed in combination in this manner, the worker may immediately determine an optimal loading shape and efficiency without relying solely on experience. Accordingly, the screen of the terminal device may function as a mixed reality-based work instruction interface in which actual cargo and expected loaded cargo are simultaneously displayed.

FIG. 6 is a diagram of an example computing device.

Referring to FIG. 6, a method and an apparatus for providing work instructions in air cargo logistics may be implemented by using a computing device 50. Such a computing device 50 may be implemented as various forms of electronic devices, servers, or similar devices, and its functions may be implemented through a combination of software and hardware.

The computing device 50 may include at least one of a processor 510, a memory 530, a user interface input device 540, a user interface output device 550, and a storage device 560, which communicate with each other through a bus 520. The computing device 50 may further include a network interface 570 electrically connected to a network 40. The network interface 570 may transmit or receive signals with other entities through the network 40.

The processor 510 may be implemented as various types of processing devices, for example, a micro controller unit (MCU), an application processor (AP), a central processing unit (CPU), a graphic processing unit (GPU), a neural processing unit (NPU), or a quantum processing unit (QPU). The processor 510 may be a semiconductor device that executes instructions stored in the memory 530 or the storage device 560 and may perform a central role of the system. Program code and data stored in the memory 530 or the storage device 560 instruct the processor 510 to perform specific tasks, thereby enabling operation of the entire system. The processor 510 may thereby be configured to implement various functions and methods described above with reference to FIGS. 1 to 5.

The memory 530 and the storage device 560 may include various types of volatile or non-volatile storage media for storing and accessing system data. For example, the memory 530 may include a read-only memory (ROM) 531 and a random access memory (RAM) 532. The memory 530 may be embedded within the processor 510, in which case the data transfer speed between the memory 530 and the processor 510 may be very high. The memory 530 may be located outside the processor 510, in which case the memory 530 may be connected to the processor 510 through various data buses or interfaces. Such connections may be made through various known means, for example, a Peripheral Component Interconnect Express (PCIe) interface or a memory controller for high-speed data transfer.

At least a part of the configurations or functions of the method and apparatus for providing work instructions in air cargo logistics may be implemented as a program or software executed by the computing device 50, and the program or software may be stored in a computer-readable recording medium or storage medium. Specifically, a computer-readable recording medium or storage medium may record a program for executing steps included in the implementation of the method and apparatus for providing work instructions in air cargo logistics, on a computer including the processor 510 executing programs or commands stored in the memory 530 or the storage device 560.

At least a part of the configurations or functions of the method and apparatus for providing work instructions in air cargo logistics may be implemented using hardware or circuitry of the computing device 50, or may be implemented as separate hardware or circuitry that can be electrically connected to the computing device 50.

One or more non-transitory computer-readable media including instructions executable by the computing device 50 may be provided, and the instructions, when executed by one or more processors of the computing device 50, may cause the computing device 50 to perform operations. Here, the operations may include the configurations, functions, and steps described in the present specification regarding the method and apparatus for providing work instructions in air cargo logistics.

A method for providing work instructions in air cargo logistics is executed in a terminal device equipped with a camera, and may include: recognizing a parcel through the camera of the terminal device and extracting information on the parcel; generating or predicting a unit decomposition model of the parcel based on the extracted information; recognizing environmental information and user information of the terminal device and determining a loading worksite; and applying the unit decomposition model and a loading algorithm to calculate an expected loading shape of a Unit Load Device (ULD) and outputting the expected loading shape through augmented reality (AR).

The recognizing the parcel through the camera of the terminal device and extracting information on the parcel may include: utilizing an Air Waybill (AWB) as a unique ID of the parcel at a reservation stage; managing a quantity of Pieces (PCS) units of the parcel as a key value; and quantifying separation number information by using a post-warehousing inspection and a Volume Measurement System (VMS).

The generating or predicting the unit decomposition model of the parcel may include: generating modeling data based on the separation number information measured by the VMS; and mapping the modeling data with an auxiliary database to construct a digital shape of the parcel.

The generating or predicting the unit decomposition model of the parcel may include: extracting an exterior surface of the modeling data and assigning an ID to each PCS unit; and predicting dimensions of the PCS units.

The generating or predicting the unit decomposition model of the parcel may include: analyzing and dividing boundary surfaces of the modeling data by step differences; and correcting the decomposition model of the PCS units by inferring deficient or excessive components using correlations between boxes.

The generating or predicting the unit decomposition model of the parcel may include: estimating individual boxes as a cluster of regular cargo when World Dimensions (WLDs) of the individual boxes analyzed in a decomposition process of the parcel exhibit the same pattern within an error range.

The method may further include: when the individual boxes are estimated as a cluster of regular cargo, decomposing the entire parcel based on a combination of the WLDs and a number of PCS units; and switching to an irregular cargo cluster pattern analysis when conditions of the regular cargo cluster are not satisfied.

The generating or predicting the unit decomposition model of the parcel may include: assigning dimensions to each individual ID cargo when it is confirmed in the irregular cargo cluster pattern analysis that all photographed cargo are in a box shape.

The method may further include: estimating cargo in blind spots that are not directly recognized during the irregular cargo cluster pattern analysis and reflecting the estimated cargo in the decomposition model of the PCS units.

The method may further include: when recognizing the ULD with the camera, displaying an outer shape of the ULD as a boundary area and outputting expected loaded cargo as a translucent object through AR.

An apparatus for providing work instructions in air cargo logistics, include: one or more non-transitory computer-readable media including instructions; and one or more processors configured to perform operations by executing the instructions, the operations including: recognizing a parcel through a camera of a terminal device and extracting information on the parcel; generating or predicting a unit decomposition model of the parcel based on the extracted information; recognizing environmental information and user information of the terminal device and determining a loading worksite; and applying the unit decomposition model and a loading algorithm to calculate an expected loading shape of a Unit Load Device (ULD) and outputting the expected loading shape through augmented reality (AR).

The recognizing the parcel through the camera of the terminal device and extracting information on the parcel may include: utilizing an Air Waybill (AWB) as a unique ID of the parcel at a reservation stage; managing a quantity of Pieces (PCS) units of the parcel as a key value; and quantifying separation number information by using a post-warehousing inspection and a Volume Measurement System (VMS).

The generating or predicting the unit decomposition model of the parcel may include: generating modeling data based on the separation number information measured by the VMS; and mapping the modeling data with an auxiliary database to construct a digital shape of the parcel.

The generating or predicting the unit decomposition model of the parcel may include: extracting an exterior surface of the modeling data and assigning an ID to each PCS unit; and predicting dimensions of the PCS units.

The generating or predicting the unit decomposition model of the parcel may include: analyzing and dividing boundary surfaces of the modeling data by step differences; and correcting the decomposition model of the PCS units by inferring deficient or excessive components using correlations between boxes.

The generating or predicting the unit decomposition model of the parcel may include: estimating individual boxes as a cluster of regular cargo when World Dimensions (WLDs) of the individual boxes analyzed in a decomposition process of the parcel exhibit the same pattern within an error range.

The operations may further include: when the individual boxes are estimated as a cluster of regular cargo, decomposing the entire parcel based on a combination of the WLDs and a number of PCS units; and switching to an irregular cargo cluster pattern analysis when conditions of the regular cargo cluster are not satisfied.

The generating or predicting the unit decomposition model of the parcel may include: assigning dimensions to each individual ID cargo when it is confirmed in the irregular cargo cluster pattern analysis that all photographed cargo are in a box shape.

The operations may further include: estimating cargo in blind spots that are not directly recognized during the irregular cargo cluster pattern analysis and reflecting the estimated cargo in the decomposition model of the PCS units.

A computer-readable medium may include one or more non-transitory computer-readable media including instructions executable by a computing device, wherein the instructions, when executed by one or more processors of the computing device, cause the computing device to perform operations including: recognizing a parcel through a camera of a terminal device and extracting information on the parcel; generating or predicting a unit decomposition model of the parcel based on the extracted information; recognizing environmental information and user information of the terminal device and determining a loading worksite; and applying the unit decomposition model and a loading algorithm to calculate an expected loading shape of a Unit Load Device (ULD) and outputting the expected loading shape through augmented reality (AR).

When loading parcels into a ULD in the air cargo field, dimensions and shapes of the individual parcels can be predicted and an accurate loading rate can be calculated. In addition, by distinguishing between regular cargo and irregular cargo and estimating cargo in blind spots, a unit decomposition model similar to an actual state can be provided. Furthermore, based on environmental information and user information, a loading worksite can be automatically designated, and by visualizing an expected loading shape and a loading rate through AR, work instructions can be provided in a highly immersive manner while reducing confusion of workers.

Although one or more example embodiments of the present disclosure have been described in detail above, the scope of the present disclosure is not limited thereto, and various modifications and improvements made by those skilled in the art using the basic concepts of the present disclosure defined in the following claims also fall within the scope of the present disclosure.

What is claimed is:

1. A method performed by an apparatus, the method comprising:
recognizing, via a camera of the apparatus, a parcel and obtaining information on the parcel;
generating, based on the obtained information, an estimated unit decomposition model of the parcel;
identifying, based on environmental information and user information of the apparatus, a loading worksite for the parcel;
determining, based on the estimated unit decomposition model, an expected loading shape of a unit load device (ULD); and
outputting, via an augmented reality (AR) device, the expected loading shape.

2. The method of claim 1, wherein the recognizing of the parcel and the obtaining of the information on the parcel comprise:
utilizing an Air Waybill (AWB) as a unique identifier of the parcel at a reservation stage;
determining a quantity of pieces (PCS) units of the parcel as a key value; and
quantifying separation number information by using a post-warehousing inspection and a volume measurement system (VMS).

3. The method of claim 2, wherein the generating of the estimated unit decomposition model of the parcel comprises:
generating modeling data based on the separation number information measured by the VMS; and
mapping the modeling data with an auxiliary database to construct a digital shape of the parcel.

4. The method of claim 3, wherein the generating of the estimated unit decomposition model of the parcel further comprises:
obtaining an exterior surface of the modeling data and assigning an identifier to each of the PCS units of the parcel; and
estimating, based on the exterior surface and the identifier, dimensions of the PCS units.

5. The method of claim 4, wherein the generating of the estimated unit decomposition model of the parcel further comprises:
distinguishing boundary surfaces of the modeling data based on positional differences in the boundary surfaces; and
adjusting the decomposition model of the PCS units by inferring deficient or excessive components using correlations between boxes.

6. The method of claim 1, wherein the generating of the estimated unit decomposition model of the parcel comprises:
estimating individual boxes as a cluster of cargo of uniform size based on dimensions of the individual boxes analyzed in a decomposition process of the parcel exhibiting a same pattern within a predetermined margin of error.

7. The method of claim 6, further comprising:
based on the individual boxes being estimated as the cluster of cargo of uniform size, decomposing the parcel based on a combination of the dimensions and a number of PCS units; and
switching to a non-uniform cargo cluster pattern analysis based on conditions of uniform cargo cluster not being satisfied.

8. The method of claim 7, wherein the generating of the estimated unit decomposition model of the parcel further comprises:
assigning dimensions to each individual cargo identifier based on the non-uniform cargo cluster pattern analysis confirming that all photographed cargo are in a box shape.

9. The method of claim 8, further comprising:
estimating cargo, in blind spots, that is not recognized during the non-uniform cargo cluster pattern analysis and applying the estimated cargo in the estimated unit decomposition model of the PCS units.

10. The method of claim 1, further comprising:
generating a signal to change a location of the camera to capture a plurality of side surface images of the ULD;
while the location of the camera is changing, obtaining the plurality of side surface images of the ULD to construct a three-dimensional model of the ULD; and
based on recognizing the ULD with the camera, displaying an outline of the ULD as a boundary area and outputting, via the AR device, expected loaded cargo as a translucent object.

11. An apparatus comprising:
a processor; and
a memory storing at least one instruction that is configured, when executed by the processor, to cause the apparatus to:
recognize, via a camera associated with the apparatus, a parcel and obtain information on the parcel;
generate, based on the obtained information, an estimated unit decomposition model of the parcel;
identify, based on environmental information and user information of the apparatus, a loading worksite for the parcel;
determine, based on the estimated unit decomposition model, an expected loading shape of a unit load device (ULD); and
output, via an augmented reality (AR) device, the expected loading shape.

12. The apparatus of claim 11, wherein the at least one instruction is configured, when executed by the processor, to cause the apparatus to recognize the parcel and obtain the information on the parcel by:
utilizing an Air Waybill (AWB) as a unique identifier of the parcel at a reservation stage;
determining a quantity of pieces (PCS) units of the parcel as a key value; and
quantifying separation number information by using a post-warehousing inspection and a volume measurement system (VMS).

13. The apparatus of claim 12, wherein the at least one instruction is configured, when executed by the processor, to cause the apparatus to generate the estimated unit decomposition model of the parcel by:
generating modeling data based on the separation number information measured by the VMS; and
mapping the modeling data with an auxiliary database to construct a digital shape of the parcel.

14. The apparatus of claim 13, wherein the at least one instruction is configured, when executed by the processor, to cause the apparatus to generate the estimated unit decomposition model of the parcel further by:
obtaining an exterior surface of the modeling data and assigning an identifier to each of the PCS units of the parcel; and
estimating, based on the exterior surface and the identifier, dimensions of the PCS units.

15. The apparatus of claim 14, wherein the at least one instruction is configured, when executed by the processor, to cause the apparatus to generate the estimated unit decomposition model of the parcel further by:
distinguishing boundary surfaces of the modeling data based on positional differences in the boundary surfaces; and
adjusting the decomposition model of the PCS units by inferring deficient or excessive components using correlations between boxes.

16. The apparatus of claim 11, wherein the at least one instruction is configured, when executed by the processor, to cause the apparatus to generate the estimated unit decomposition model of the parcel by:
estimating individual boxes as a cluster of cargo of uniform size based on dimensions of the individual boxes analyzed in a decomposition process of the parcel exhibiting a same pattern within a predetermined margin of error.

17. The apparatus of claim 16, wherein the at least one instruction is configured, when executed by the processor, to further cause the apparatus to:
based on the individual boxes being estimated as the cluster of cargo of uniform size, decomposing the parcel based on a combination of the dimensions and a number of PCS units; and
switching to a non-uniform cargo cluster pattern analysis based on conditions of uniform cargo cluster not being satisfied.

18. The apparatus of claim 17, wherein the at least one instruction is configured, when executed by the processor, to further cause the apparatus to generate the estimated unit decomposition model of the parcel further by:
assigning dimensions to each individual cargo identifier based on the non-uniform cargo cluster pattern analysis confirming that all photographed cargo are in a box shape.

19. The apparatus of claim 18, wherein the at least one instruction is configured, when executed by the processor, to further cause the apparatus to:
estimate cargo, in blind spots, that is not recognized during the non-uniform cargo cluster pattern analysis and applying the estimated cargo in the decomposition model of the PCS units.

20. One or more non-transitory computer-readable media storing instructions that, when executed by a computing device, cause the computing device to:
recognize, via a camera associated with the computing device, a parcel and obtain information on the parcel;
generate, based on the obtained information, an estimated unit decomposition model of the parcel;
identify, based on environmental information and user information of the computing device, a loading worksite for the parcel;
determine, based on the estimated unit decomposition model, an expected loading shape of a unit load device (ULD); and
output, via an augmented reality (AR) device, the expected loading shape.
